(19) United States
(12) Patent Application Publication
(10) Pub. No.: US 2021/0141269 A1
(43) Pub. Date: May 13, 2021

(54) POLARIZER ATTACHMENT DEVICE AND POLARIZER ATTACHMENT METHOD

(71) Applicant: SAKAI DISPLAY PRODUCTS CORPORATION, Sakai-shi, Osaka, (JP)

(72) Inventor: KATSUNORI NAGATA, Sakai-shi, Osaka (JP)

(21) Appl. No.: 16/606,477

(22) PCT Filed: May 23, 2017
(86) PCT No.: PCT/JP2017/019179

§ 371 Date: Jan. 20, 2020

(51) Int. Cl. G02F 1/1335; G02B 5/30

(52) U.S. Cl. CPC G02F 1/133528; G02F 1/133516; G02B 5/30

(57) ABSTRACT

A polarizer attachment device 1 comprises: a supply unit 10 for pulling a strip-like raw polarizer 2 from a feed roll 5 to supply the same to a panel; a peeling unit 11 for peeling a separator film 2c; a transfer unit 13 for transferring a liquid crystal panel 4; an attachment unit 14 for attaching the raw polarizer 2 to the liquid crystal panel 4; an attachment detection unit 15 for detecting the attachment state of the raw polarizer 2; a raw-polarizer cutting unit 17 for cutting the raw polarizer 2; and a control device 30. The control device 30 includes: a cutting determination unit 31 that determines it is possible to cut the raw polarizer 2 when the attachment detection unit 15 detects that it is after the completion of the attachment of the raw polarizer 2 to the liquid crystal panel 4 and after the start of the attachment of the raw polarizer 2 to another liquid crystal panel 4; and a first cutting control unit 32 that controls the raw-polarizer cutting unit 17 to allow the same to cut the raw polarizer 2 between the liquid crystal panels 4 when the cutting determination unit 31 determines that it is possible to cut the raw polarizer 2.

### TECHNICAL FIELD

The present invention relates to a polarizing plate attachment apparatus and a polarizing plate attachment method.

### BACKGROUND ART

A polarizing plate is attached to a panel such as a liquid-crystal panel in course of production. Typically, a sheet-by-sheet attachment method is employed in many cases for polarizing plate attachment in terms of a high degree of freedom in handling and coping with a variety of attachment manners. For example. Patent Literature 1 discloses a sheet-by-sheet attachment method such as above.

### CITATION LIST

### Patent Literature

### [Patent Literature 1]

Japanese Patent Application Laid-Open Publication No. 2000-258761

### SUMMARY OF INVENTION

### Technical Problem

However, in a sheet-by-sheet attachment method, a polarizing plate original sheet is cut into a size of a panel before being attached to the panel, one side (a leading edge) among long sides and short sides of the cut polarizing plate original sheet is attached to the panel, and then pressing by a roller or the like toward a side (a trailing edge) opposite to the one side of the cut polarizing plate original sheet is performed on the panel, whereby the cut polarizing plate original sheet (polarizing plate) is attached to the panel. In the above attachment method, pressing pressure applied to the polarizing plate by the roller is unstable at the leading edge and the trailing edge as compared to a central part of the polarizing plate, and therefore, an air bubble tends to be generated between the panel and the polarizing plate. When a bubble is generated as described above, a defect of a bright spot may be caused on the panel in performing display. This involves a repair operation or a scrap operation, resulting in decreased yield.

The present invention has its object of providing a polarizing plate attachment apparatus and a polarizing plate attachment method that can inhibit generation of a bubble between a panel and a polarizing plate.

### Solution to Problem

A polarizing plate attachment apparatus according to one embodiment of the present invention includes:

a supply section configured to supply a polarizing plate original sheet to a first panel and a second panel by pulling out the polarizing plate original sheet from a feed roll, the polarizing plate original sheet being a belt-shaped polarizing plate original sheet including a polarizing film, an adhesive, and a separator film, the polarizing plate original sheet being wound around the feed roll;

a peeling section configured to peel off the separator film from the polarizing plate original sheet during time until the polarizing plate original sheet pulled out from the feed roll is supplied to the first panel or the second panel;

a conveyance section configured to convey the first and second panels;

an attachment section configured to attach the polarizing plate original sheet from which the separator film has been peeled off to the first and second panels through the adhesive;

an attachment detection section configured to detect an attachment state of the polarizing plate original sheet attached by the attachment section;

an original sheet cutting section configured to cut the polarizing plate original sheet; and

a controller including a cutting determination section and a cutting control section, the cutting determination section being configured to determine, when the attachment detection section detects that attachment of the polarizing plate original sheet to the first panel has been completed and attachment of the polarizing plate original sheet to the second panel conveyed subsequent to the first panel by the conveyance section has been started, that cutting of the polarizing plate original sheet is enabled, the cutting control section being configured to control, when the cutting determination section determines that cutting of the polarizing plate original sheet is enabled, the original sheet cutting section to cut the polarizing plate original sheet between the first panel and the second panel.

A polarizing plate attachment method according to one embodiment of the present invention includes:

providing a polarizing plate original sheet, a first panel, and a second panel, the polarizing plate original sheet being a belt-shaped polarizing plate original sheet including a polarizing film, an adhesive, and a separator film;

peeling off the separator film from the polarizing plate original sheet;

supplying to the first and second panels the polarizing plate original sheet from which the separator film has been peeled off; and

cutting, after a completion of attachment of the polarizing plate original sheet to the first panel and after a start of attachment of the polarizing plate original sheet to the second panel, the polarizing plate original sheet continuously attached to the first panel and the second panel in a line between the first panel and the second panel, the second panel being conveyed subsequently to the first panel.

### Advantageous Effects of Invention

In the polarizing plate attachment apparatus and the polarizing plate attachment method according to the present invention, the belt-shaped polarizing plate original sheet is continuously attached to the panel and cut after attachment into the polarizing plate having a specific size, thereby inhibiting generation of a bubble between the panels and the polarizing plates.

### BRIEF DESCRIPTION OF DRAWINGS

FIG. 1 is a diagram illustrating a first schematic configuration of a polarizing plate attachment apparatus according to an embodiment of the present invention.

FIG. 2 is a perspective view illustrating details of a conveyance section in FIG. 1.

FIG. 3 is a block diagram of a controller in FIG. 1.

FIG. 4 is a diagram illustrating a second schematic configuration of the polarizing plate attachment apparatus according to the embodiment.

FIG. 5 is a diagram illustrating a third schematic configuration of the polarizing plate attachment apparatus according to the embodiment.

FIG. 6 is a diagram illustrating a fourth schematic configuration of the polarizing plate attachment apparatus according to the embodiment.

FIG. 7 is a diagram illustrating a schematic overall configuration of the polarizing plate attachment apparatus according to the embodiment.

### DESCRIPTION OF EMBODIMENTS

The following describes an embodiment of the present invention with reference to the accompanying drawings.

FIG. 1 is a diagram illustrating a schematic configuration of a polarizing plate attachment apparatus 1 according to an embodiment of the present invention. The polarizing plate attachment apparatus 1 is an apparatus that attaches a belt-shaped polarizing plate original sheet 2 (generally called a polarizing plate roll) wound around a feed roll 5 to a liquid-crystal panel 4 being an example of a panel, and then cuts the polarizing plate original sheet 2 into a polarizing plate 3 having a specific size. While FIG. 1 illustrates five liquid-crystal panels 4a to 4e, each of them may be referred to as a liquid-crystal panel 4 when there is no need to distinguish the liquid-crystal panel.

As illustrated in an enlarged scale in a circle enclosed by a dashed and double dotted line in FIG. 1, the polarizing plate original sheet 2 is a multilayer film. The polarizing plate original sheet 2 in the present embodiment is constituted by a protection film 2a, a polarizing film 2b, and a separator film 2c. An adhesive 2d is applied between the polarizing film 2b and the separator film 2c. The protection film 2a is located at the most outside of the polarizing plate original sheet 2 in a state in which the polarizing plate original sheet 2 is attached to a liquid-crystal panel 4. The term outside herein means an outer surface side of the polarizing plate original sheet 2 (a side opposite to the liquid-crystal panels 4) in a state in which the polarizing plate original sheet 2 is attached to the liquid-crystal panel 4. On the other hand, the term inside herein means a side of the liquid-crystal panels 4. Accordingly, the protection film 2a serves as an outer surface in a state in which the polarizing plate original sheet 2 is attached to a liquid-crystal panel 4, and protects the polarizing film 2b disposed inside the protection film 2a from external stimulus. The protection film 2a is a laminate film made of synthetic resin, for example. The polarizing film 2b is a polarizable film located inside the protection film 2a in a state in which the polarizing plate original sheet 2 is attached to a liquid-crystal panel 4. The polarizing film 2b is formed of for example two triacetylcellulose (TAC) films with one polyvinyl alcohol (PVA) film therebetween. The separator film 2c is disposed inside the polarizing film 2b through the adhesive. The separator film 2c is provided for protecting the adhesive from foreign matter such as dust, and is a laminate film made of for example synthetic resin. Note that the polarizing plate original sheet 2 in the present embodiment bears an NG mark indicating a defective point as will be described later.

A configuration of the polarizing plate attachment apparatus 1 will be described first. The polarizing plate attachment apparatus 1 includes a supply section 10, a peeling section 11, an NG mark detection section 12, a conveyance section 13, an attachment section 14, an attachment detection section 15, a pressing section 16, an original sheet cutting section 17, an aligning and cutting section 18, and a controller 30.

The supply section 10 pulls out the polarizing plate original sheet 2 from the feed roll 5 around which the polarizing plate original sheet 2 is wound to supply the polarizing plate original sheet 2 to the liquid-crystal panels 4. The supply section 10 includes a plurality of direction changing rollers 10a to 10d. The polarizing plate original sheet 2 is supplied to the liquid-crystal panels 4 from the feed roll 5 via the plurality of direction changing rollers 10a to 10d. One direction changing roller 10b of the direction changing rollers 10a to 10d is vertically movable. In the above configuration, tension applied to the polarizing plate original sheet 2 can be adjusted by adjusting the position of the direction changing roller 10b.

The peeling section 11 peels off the separator film 2c from the polarizing plate original sheet 2 during time until the polarizing plate original sheet 2 pulled out from the feed roll 5 is supplied to a liquid-crystal panel 4 by the supply section 10. The peeling section 11 in the present embodiment is composed of a separator bar 11a. The separator bar 11a has a columnar shape and a position thereof is fixed. The polarizing plate original sheet 2 from which the separator film 2c has been peeled off is supplied to the liquid-crystal panels 4. The separator film 2c peeled here is wound up around a winding roll 6.

The NG mark detection section 12 detects an NG mark borne on the polarizing plate original sheet 2 in a range from the supply section 10 to a liquid-crystal panel 4. It is difficult to produce a perfect polarizing plate original sheet 2 in light of production, and therefore, the polarizing plate original sheet 2 has a given number of defects. When a region of the polarizing plate original sheet 2 having such a defect is attached as the polarizing plate 3 to a liquid-crystal panel 4, poor visibility resulting from for example a bright spot may be caused on a display surface of the liquid-crystal panel 4. In view of the foregoing, the polarizing plate original sheet 2 is preferably used except a region thereof having such a defect. An NG mark indicating a position of a defect is provided on the polarizing plate original sheet 2 in many cases so as not to use a region having such a defect as the polarizing plate 3. The NG mark includes various types of marks including for example a mark directly provided at a point where a defect is caused and a mark provided at an end of the polarizing plate original sheet 2 to indicate a region having a defect. A line camera or a camera arranged to be able to perform linear capture is employed for the NG mark detection section 12 in the present embodiment in order to address various types of NG marks. In the above configuration, the NG mark detection section 12 captures a line perpendicular to a supply direction of the polarizing plate original sheet 2 one time on a plane of the polarizing plate original sheet 2, and detects an NG mark borne on the line. A result of detection by the NG mark detection section 12 is transmitted to the controller, which will be described later.

The conveyance section 13 conveys the liquid-crystal panels 4. The conveyance section 13 includes conveyance rollers 13a that convey the liquid-crystal panels 4, and an alignment stage 13b capable of changing the position of a liquid-crystal panel 4 on the conveyance rollers 13a.

As illustrated in FIG. 2, the conveyance rollers 13a are disposed at regular intervals and each are columnar in shape. The conveyance rollers 13a are rotationally driven by an unillustrated driving device, and are changeable in rotational speed. In the above configuration in the present embodiment, the conveyance speed of the liquid-crystal panels 4 placed thereon can be changed by changing the rotational speed of the conveyance rollers 13a. An opening M is located in a region of the conveyance rollers 13a on which a later-described alignment process is executed. The alignment stage 13b ascends and descends through opening M. The alignment stage 13b is a movable stage having a flat upper surface. The alignment stage 13b is usually positioned below the conveyance rollers 13a, and is brought up through the opening M by an unillustrated driving device to bring up a liquid-crystal panel 4 in execution of the alignment process, which will be described later. That is, the liquid-crystal panel 4 is in a state of being separate from the conveyance rollers 13a and placed on the alignment stage 13b. The upper surface of the alignment stage 13b has a plurality of minute suction holes (not illustrated) connected to an unillustrated vacuum device. The air is sucked though the suction holes. Thus, the liquid-crystal panel 4 is sucked to the upper surface of the alignment stage 13b. Attachment accuracy of the polarizing plate original sheet 2 in the later-described attachment process is increased by adjusting the position in a conveyance direction of the liquid-crystal panel 4 and an angle of the liquid-crystal panel 4 on a horizontal plane to be in respective prescribed ranges in the sucked state. After the above adjustment, suction through the alignment stage 13b is stopped and the alignment stage 13b is brought down through the opening M to bring down the liquid-crystal panel 4. That is, the liquid-crystal panel 4 is separated from the alignment stage 13b to be in a state of being placed on the conveyance rollers 13a again.

In the configuration as described above, the conveyance section 13 includes two conveyance means of the conveyance rollers 13a and the alignment stage 13b. Thus, a degree of conveyance freedom can be increased. For example, it is possible that the liquid-crystal panels 4 are usually conveyed by the conveyance rollers 13a and the position and orientation of a liquid-crystal panel 4 are corrected as needed using the alignment stage 13b. Moreover, each liquid-crystal panel 4 can be conveyed with a specific timing as needed using the alignment stage 13b.

As illustrated in FIG. 1, the attachment section 14 attaches the polarizing plate original sheet 2 from which the separator film 2c has been peeled off to the liquid-crystal panels 4. In the present embodiment, while the conveyance section 13 conveys the liquid-crystal panels 4, the attachment section 14 attaches the polarizing plate original sheet 2 to a liquid-crystal panel 4 under conveyance. The attachment section 14 in the present embodiment includes a pair of attachment rollers 14a and 14b that are arranged vertically and that have the same size as each other. The lower attachment roller 14b is fixed in position, while the upper attachment roller 14a is vertically movable. The polarizing plate original sheet 2 is supplied to the liquid-crystal panels 4 so as to pass between the pair of attachment rollers 14a and 14b. The polarizing plate original sheet 2 can be attached to a liquid-crystal panel 4 through the adhesive by being pressed against the liquid-crystal panel 4 through the upper attachment roller 14a being brought close to the lower attachment roller 14b.

The attachment detection section 15 detects an attachment state of the polarizing plate original sheet 2 attached by the attachment section 14. The attachment detection section 15 in the present embodiment is a pressure sensor and detects a load pressure applied to the attachment rollers 14a and 14b. The attachment detection section 15 is capable of detecting a start of attachment of the polarizing plate original sheet 2 to a liquid-crystal panel 4 through detection of the load pressure being a specific value or larger. The attachment detection section 15 is capable of further detecting a completion of attachment of the polarizing plate original sheet 2 to the liquid-crystal panel 4 through detection of the load pressure being a specific value or smaller. However, the attachment detection section 15 is not limited to the pressure sensor and only need detect an attachment state. Therefore, the attachment detection section 15 may be in any form such as a contact sensor or an image sensor.

The pressing section 16 is located downstream of the attachment section 14 in terms of a conveyance direction of the liquid-crystal panels 4, and secures by pressing a liquid-crystal panel 4 to which the polarizing plate original sheet 2 has been attached. The pressing section 16 in the present embodiment includes a plurality of pressing rollers 16a arranged in the conveyance direction of the liquid-crystal panels 4 above the liquid-crystal panels 4 under conveyance. The pressing rollers 16a are vertically movable, and can secure by pressing a liquid-crystal panel 4 to the polarizing plate original sheet 2 through descent thereof.

A liquid-crystal panel 4 can be secured by the pressing section 16 in attachment of the polarizing plate original sheet 2 to the liquid-crystal panel 4. Thus, conveyance of the liquid-crystal panel 4 can be assisted. Specifically, the polarizing plate original sheet 2 is in a belt shape and is attached continuously. Therefore, tension is caused in the polarizing plate original sheet 2. In attachment of the polarizing plate original sheet 2 to a subsequent liquid-crystal panel 4 (the liquid-crystal panel 4b in the example illustrated in FIG. 6), an antecedent liquid-crystal panel 4 (the liquid-crystal panel 4c in the example illustrated in FIG. 6) is pulled toward the supply section by the tension through the polarizing plate original sheet 2. However, the antecedent liquid-crystal panel 4 can be secured by the pressing section 16, and therefore, conveyance of the antecedent liquid-crystal panel 4 can be assisted against the tension.

The original sheet cutting section 17 cuts the polarizing plate original sheet 2. The original sheet cutting section 17 is disposed between the pressing rollers 16a of the pressing section 16 in terms of the conveyance direction of the liquid-crystal panels 4. As will be described later, the original sheet cutting section 17 is controlled by a first cutting control section (cutting control section) 32 to cut the polarizing plate original sheet 2, which has been continuously attached in a line to a liquid-crystal panel 4 (a first panel) and a liquid-crystal panel 4 (a second panel), between the liquid-crystal panel 4 (the first panel) and the liquid-crystal panel 4 (the second panel). The original sheet cutting section 17 in the present embodiment cuts the polarizing plate original sheet 2 perpendicularly to the conveyance direction of the liquid-crystal panels 4 by laser irradiation. However, the original sheet cutting section 17 is not limited to that using a laser and may be for example a cutting section that performs mechanical cutting using a blade.

The aligning and cutting section 18 has the same configuration as the original sheet cutting section 17 in all aspects other than its position. The aligning and cutting section 18 is disposed downstream of the original sheet cutting section 17 and the pressing section 16 in terms of the conveyance direction of the liquid-crystal panels 4, and located the most downstream among the elements of configuration provided in the polarizing plate attachment apparatus 1 in the present embodiment. As will be described later, the aligning and cutting section 18 is controlled by a second cutting control section 33 to cut the leading edge of the polarizing plate original sheet 2 attached to a liquid-crystal panel 4 (the first panel) in terms of the conveyance direction of the liquid-crystal panels 4.

The controller 30 is constituted by hardware including a storage device such as a central processing unit (CPU), random access memory (RAM), or read-only memory (ROM), and software implemented by the hardware. As illustrated in FIG. 3, the controller 30 in the present embodiment includes a cutting determination section 31, a first cutting control section 32, a second cutting control section 33, a conveyance speed control section 35, and a pressing section control section 36.

When the attachment detection section 15 detects that attachment of the polarizing plate original sheet 2 to a liquid-crystal panel 4 (the first panel) by the attachment section 14 has been completed and attachment of the polarizing plate original sheet 2 to another liquid-crystal panel 4 (the second panel) conveyed subsequent to the liquid-crystal panel 4 (first panel) by the conveyance section 13 has been started, the cutting determination section 31 determines that cutting of the polarizing plate original sheet 2 is enabled.

When the cutting determination section 31 determines that the cutting of the polarizing plate original sheet 2 is enabled, the first cutting control section 32 controls the original sheet cutting section 17 to cut, between the liquid-crystal panel 4d (the first panel) and the liquid-crystal panel 4c (the second panel), the polarizing plate original sheet 2 continuously attached in a line to the liquid-crystal panel 4d (the first panel) and the liquid-crystal panel 4c (the second panel). Specifically, the pressure sensor being the attachment detection section 15 detects the load pressure being the specific value or larger, that is, detects a start of attachment of the polarizing plate original sheet 2 to the liquid-crystal panel 4d (the first panel). Thereafter, the pressure sensor being the attachment detection section 15 detects the load pressure being the specific value or smaller, that is, detects a completion of attachment of the polarizing plate original sheet 2 to the liquid-crystal panel 4d (the first panel). The pressure sensor then detects the load pressure being the specific value or larger, that is, detects a start of attachment of the polarizing plate original sheet 2 to the liquid-crystal panel 4c (the second panel). Through the above, the cutting determination section 31 determines that cutting of the polarizing plate original sheet 2 is enabled. After the cutting determination section 31 determines cutting being enabled, the above-described control is performed on the original sheet cutting section 17 to cut the polarizing plate original sheet 2.

The second cutting control section 33 controls the aligning and cutting section 18 to cut the leading edge of the polarizing plate original sheet 2 in a conveyance direction of the first and second panels that is attached to the liquid-crystal panel 4e and that has a trailing edge cut by the original sheet cutting section 17. Through the above cutting, the polarizing plate original sheet 2 is cut into the polarizing plate 3 having a specific size (size of a product).

Upon the NG mark detection section 12 detecting an NG mark, the conveyance speed control section 35 controls the conveyance speed of the liquid-crystal panel 4d (the first panel) and the liquid-crystal panel 4c (the second panel) each conveyed by the conveyance section 13 so that a part of the polarizing plate original sheet 2 where the NG mark is borne is positioned between the liquid-crystal panel 4d (the first panel) and the liquid-crystal panel 4c (the second panel). That is, when the NG mark detection section 12 detects an NG mark, the conveyance speed control section 35 controls the conveyance section 13 so that a part of the polarizing plate original sheet 2 where the NG mark is borne is not attached to a liquid-crystal panel 4. More specifically, when the NG mark detection section 12 detects an NG mark, rotation of the conveyance rollers 13a of the conveyance section 13 is suspended or reduced for a specific time period to suspend supply of a liquid-crystal panel 4 to the attachment section 14 for a specific time period. Through the above, the polarizing plate original sheet 2 is fed downstream without the part of the polarizing plate original sheet 2 where the NG mark is borne being attached to a liquid-crystal panel 4. Thereafter, the part thereof is cut and removed. Alternatively, the conveyance speed control section 35 may suspend operation of the conveyance section 13 with a liquid-crystal panel 4 remaining placed on the alignment stage 13b for a specific time period to suspend supply of the liquid-crystal panel 4 to the attachment section 14 for a specific time period.

The pressing section control section 36 controls the pressing section 16 to assist conveyance of a liquid-crystal panel 4 by securing the liquid-crystal panel 4 as described above. Specifically, the pressing section 16 under the above control secures the liquid-crystal panel 4 until the polarizing plate original sheet 2 is cut by the original sheet cutting section 17. This is because upon the polarizing plate original sheet 2 being cut by the original sheet cutting section 17, tension applied to the polarizing plate original sheet 2 is released. In detail, once the polarizing plate original sheet 2 is cut by the original sheet cutting section 17, the liquid-crystal panel 4 is not pulled by the tension of the polarizing plate original sheet 2 to be returned toward the supply section 10 even unless the pressing section 16 secures the liquid-crystal panel 4.

The following describes operation and effects of the polarizing plate attachment apparatus 1 having the above configuration on a process-by-process basis. Use of the polarizing plate attachment apparatus 1 according to the present embodiment enables successive attachment of the polarizing plates 3 to a plurality of liquid-crystal panels 4a to 4e. In FIG. 1, five liquid-crystal panels 4a to 4e are arranged in the polarizing plate attachment apparatus 1 and being subjected to processing of respectively corresponding processes. Specifically, the five liquid-crystal panels 4a to 4e are under any of an input process (a process on the liquid-crystal panel 4a) an alignment process (a process on the liquid-crystal panel 4b), an attachment process (a process on the liquid-crystal panel 4c), a first cutting process (a process on the liquid-crystal panel 4d), and a second cutting process (a process on the liquid-crystal panel 4e).

In the input process, the liquid-crystal panel 4a is input to the polarizing plate attachment apparatus 1. In FIG. 1, the liquid-crystal panel 4a is in a state directly after input. In this state, the polarizing plate original sheet 2 is not attached to the liquid-crystal panel 4a. The liquid-crystal panel 4a is thereafter conveyed to the alignment stage 13b by the conveyance rollers 13a, that is, fed to a site of the alignment process.

In the alignment process, the liquid-crystal panel 4b placed on the alignment stage 13b before attachment of the polarizing plate original sheet 2 thereto is subjected to positional and directional adjustment. The liquid-crystal panel 4b is then conveyed to the attachment section 14 by the conveyance rollers 13a, that is, fed to a site of the attachment process.

In the attachment process, the polarizing plate original sheet 2 is attached to the liquid-crystal panel 4c using the pair of attachment rollers 14a and 14b. The polarizing plate original sheet 2 is attached to the liquid-crystal panel 4c from front to rear in terms of a conveyance direction of the liquid-crystal panel 4c. Then, the liquid-crystal panel 4c is conveyed to the original sheet cutting section 17 by the conveyance rollers 13a, that is, fed to a site of the first cutting process.

In the first cutting process, the trailing edge of the polarizing plate original sheet 2 attached to the liquid-crystal panel 4d is cut by the original sheet cutting section 17. Through the cutting, the polarizing plate original sheet 2 is cut aligned with a trailing par of the liquid-crystal panel 4c into the size of the polarizing plate 3 as a product to which the polarizing plate original sheet 2 has been attached. In so doing, the polarizing plate original sheet 2 is cut between the liquid-crystal panel 4d (the first panel) and the liquid-crystal panel 4c (the second panel) only after attachment of the polarizing plate original sheet 2 to the liquid-crystal panel 4c (the second panel) is completed as described above. Then, the liquid-crystal panel 4d is conveyed to the aligning and cutting section 18 by the conveyance rollers 13a, that is, fed to a site of the second cutting process.

In the second cutting process, the leading edge of the polarizing plate original sheet 2 attached to the liquid-crystal panel 4e is cut by the aligning and cutting section 18. Through the above cutting, the polarizing plate original sheet 2 around a leading part of the liquid-crystal panel 4e is cut aligned into the size of the polarizing plate 3 as a product to which the polarizing plate original sheet 2 has been attached Note that the liquid-crystal panel 4e in FIG. 1 is in a state of having been subjected to all the processes for attachment of the polarizing plate 3 by the polarizing plate attachment apparatus 1 including the second cutting process. Thereafter, the liquid-crystal panel 4e is conveyed by the conveyance rollers 13a to be fed to a site of a later process.

FIG. 4 illustrates a state after a given time elapses from the state illustrated in FIG. 1. Specifically, the liquid-crystal panel 4a has been subjected to the input process and is being fed to the site of the alignment process. The liquid-crystal panel 4b has been subjected to the alignment process and is being fed to the site of the attachment process. The liquid-crystal panel 4c is in a state of having been subjected to the attachment process and is being fed to the site of the second cutting process while being secured by the pressing section 16. The liquid-crystal panel 4d has been subjected to the first cutting process and is being fed to the site of the second cutting process with the trailing edge of the polarizing plate original sheet 2 cut. Note that no tension acts on the polarizing plate original sheet 2 and it is not necessary to assist conveyance using the pressing section 16 in a state in which the trailing edge of the polarizing plate original sheet 2 is cut, and therefore, the liquid-crystal panel 4d is not secured by the conveyance rollers 13a of the pressing section 16.

FIG. 5 illustrates a state after a given time elapses from the state illustrated in FIG. 4. Specifically, another liquid-crystal panel 4f has been input to the polarizing plate attachment apparatus 1 for the input process. Positional and directional adjustment by the alignment stage 13b on the liquid-crystal panel 4a has been started in the alignment process. The liquid-crystal panel 4b is being fed to the site of the attachment process. The liquid-crystal panel 4c has been subjected to the attachment process of attaching the polarizing plate original sheet 2 and fed to the site of the first cutting process while being secured by the pressing section 16. The liquid-crystal panel 4c is in a standby state, waiting for the first cutting process until attachment of the polarizing plate original sheet 2 to the liquid-crystal panel 4b is completed. The liquid-crystal panel 4d is in a state in which the leading edge of the polarizing plate original sheet 2 is being cut in the second cutting process.

FIG. 6 illustrates a state after a given time elapses from the state illustrated in FIG. 5. Specifically, the liquid-crystal panel 4f is being fed to the site of the alignment process. The liquid-crystal panel 4a has been subjected to the alignment process. Attachment of the polarizing plate original sheet 2 to the liquid-crystal panel 4b has been started in the attachment process. The liquid-crystal panel 4c is in a standby state, waiting for the first cutting process while being secured by the pressing section 16 until attachment of the polarizing plate original sheet 2 to the liquid-crystal panel 4b is completed. The liquid-crystal panel 4d has been subjected to the second cutting process.

Through the above, a polarizing plate 3 is attached to a liquid-crystal panel 4 through each process by the polarizing plate attachment apparatus 1. The polarizing plate 3 is attached to each of two main surfaces of the liquid-crystal panel 4. In the polarizing plate attachment apparatus 1 according to the present embodiment performs the same processes as the above processes in a line B with the liquid-crystal panel 4 turned over as illustrated in FIG. 7 after the above processes are completed in a line A. Although the line A and the line B crosses at a right angle to form an L shape in a plan view in the present embodiment, no particular limitations are placed on the aspect thereof.

According to the present embodiment, the belt-shaped polarizing plate original sheet 2 is continuously attached to the panels and is cut after attachment to obtain the polarizing plates 3 in an attached state. This is not a case where the polarizing plate 3 is attached starting from an end thereof. Therefore, a situation can be avoided in which air enters from an end of the polarizing plate 3 to generate a bubble between the liquid-crystal panel 4 and the polarizing plate 3. In detail, the polarizing plate original sheet 2 is cut after a start (and a completion in addition in the present embodiment) of attachment of the polarizing plate 3 to the liquid-crystal panel 4c (the second panel) as illustrated in FIG. 4, rather than directly after a completion of attachment of the polarizing plate 3 to the liquid-crystal panel 4d (the first panel). Accordingly, attachment of the polarizing plate 3 to the liquid-crystal panel 4c (the second panel) is performed with a continuous attachment state maintained. That is, in attachment of the polarizing plate 3 to the liquid-crystal panel 4c (the second panel), the polarizing plate 3 is attached in the form of the continuous polarizing plate original sheet 2, rather than attachment thereof starting from an end thereof. Further, positional alignment in a conveyance direction of the panels is unnecessary in polarizing plate attachment unlike a case where the polarizing plates 3 are attached by a sheet-by-sheet attachment method. Specifically, since the polarizing plate 3 is cut at a desired position after attachment to a panel, it is not necessary in attachment to ensure preciseness of the attachment position in the conveyance direction and is only necessary to favorably control a cutting position of the polarizing plate original sheet 2 to be cut by the original sheet cutting section 17 after attachment. Furthermore, as illustrated in FIG. 4, the liquid-crystal panel 4d (the first panel) is independent of the liquid-crystal panel 4c (the second panel) after cutting of the polarizing plate original sheet 2, and can accordingly be freely conveyed. Thus, the liquid-crystal panel 4d (the first panel) can be conveyed singly to sites of the subsequent processes (the second cutting process and the processes thereafter), and thus, a degree of freedom of processing in the subsequent processes can be increased. In addition, the separator film can be continuously and directly peeled off by the peeling section 11 before supply of the polarizing plate original sheet 2 to a panel. This means that it is not necessary to peel off the separator film on a sheet-by-sheet basis from each polarizing plate 3 as in the sheet-by-sheet attachment method.

Moreover, a point of a defect, which may cause a bright point or the like on the liquid-crystal panel 4, is indicated using the NG mark and the NG mark detection section 12 detects the NG mark. In the above configuration, the conveyance speed control section 35 controls, upon receiving information indicating that the NG mark has been detected by the NG mark detection section 12, the conveyance speed so that the polarizing plate original sheet 2 can be attached to the panels in a manner that a region of the polarizing plate original sheet 2 where the NG mark is borne is sidestepped. Thus, production of a liquid-crystal panel 4 having a defect can be obviated, thereby increasing yield.

An embodiment has been described so far. Not only elements of configuration essential to solving the problem but also some elements of configuration not essential to solving the problem are included in the elements of configuration illustrated in the accompanying drawings and described in the detailed description in order to exemplify the above-described technique. Therefore, it should not be directly acknowledged that such a non-essential element of configuration being illustrated in a drawing or being described in detail is the non-essential element of configuration being essential. Furthermore, the above-described embodiment is provided only as an example of the technique of the present disclosure, and therefore, various alterations, replacement, addition, omission, and the like can be made within a scope of claims and its equivalent scope.

For example, the original sheet cutting section 17 cuts the trailing edge of the polarizing plate 3 while the aligning and cutting section 18 cuts the leading edge thereof in the present embodiment. However, it is possible that the original sheet cutting section 17 cuts the leading edge of the polarizing plate 3 while the aligning and cutting section 18 cuts the trailing edge thereof.

For example, in a case where the polarizing plate original sheet 2 has a larger width than the liquid-crystal panels 4, a process may be added by which an edge of the polarizing plate original sheet 2 is trimmed according to the width of the liquid-crystal panels 4.

The present invention and the embodiment are summarized as follows.

In an embodiment, the polarizing plate attachment apparatus according to the present invention includes:

a supply section configured to supply a polarizing plate original sheet to a first panel and a second panel by pulling out the polarizing plate original sheet from a feed roll, the polarizing plate original sheet being a belt-shaped polarizing plate original sheet including a polarizing film, an adhesive, and a separator film, the polarizing plate original sheet being wound around the feed roll,

a peeling section configured to peel off the separator film from the polarizing plate original sheet during time until the polarizing plate original sheet pulled out from the feed roll is supplied to the first panel or the second panel;

a conveyance section configured to convey the first and second panels;

an attachment section configured to attach the polarizing plate original sheet from which the separator film has been peeled off to the first and second panels through the adhesive;

an attachment detection section configured to detect an attachment state of the polarizing plate original sheet attached by the attachment section;

an original sheet cutting section configured to cut the polarizing plate original sheet; and

a controller including a cutting determination section and a cutting control section, the cutting determination section being configured to determine, when the attachment detection section detects that attachment of the polarizing plate original sheet to the first panel has been completed and attachment of the polarizing plate original sheet to the second panel conveyed subsequent to the first panel by the conveyance section has been started, that cutting of the polarizing plate original sheet is enabled, the cutting control section being configured to control, when the cutting determination section determines that cutting of the polarizing plate original sheet is enabled, the original sheet cutting section to cut the polarizing plate original sheet between the first panel and the second panel.

In an embodiment, the polarizing plate attachment apparatus according to the present invention includes:

a supply section configured to supply a polarizing plate original sheet to a first panel and a second panel by pulling out the polarizing plate original sheet from a feed roll, the polarizing plate original sheet having a belt-like shape, the polarizing plate original sheet being wound around the feed roll,

a conveyance section configured to convey the first and second panels;

an attachment section configured to attach the polarizing plate original sheet to the first and second panels;

an attachment detection section configured to detect an attachment state of the polarizing plate original sheet attached by the attachment section;

an original sheet cutting section configured to cut the polarizing plate original sheet; and

a controller including a cutting control section configured to control, when the attachment detection section detects that attachment of the polarizing plate original sheet to the first panel has been completed and attachment of the polarizing plate original sheet to the second panel has been started, the original sheet cutting section to cut the polarizing plate original sheet between the first panel and the second panel, the second panel being conveyed subsequent to the first panel by the conveyance section.

According to the above configurations, the belt-shaped polarizing plate original sheet is continuously attached to the first and second panels (each also referred to below simply as a panel) and cut after attachment, thereby obtaining polarizing plates having a specific size. This avoids attachment of a polarizing plate starting from an end thereof. Therefore, a situation can be avoided in which air enters from an end of the polarizing plate to generate a bubble between the panel and the polarizing plate. In detail, the polarizing plate original sheet is cut after a start of attachment of the polarizing plate original sheet to the second panel rather than directly after a completion of attachment of the polarizing plate original sheet to the first panel. In the above configuration, attachment of the polarizing plate as the polarizing plate original sheet to the second panel is performed with a continuous attachment state maintained. That is, in polarizing plate attachment to the second panel, the polarizing plates are attached successively in the form of the polarizing plate original sheet rather than attachment thereof starting from ends thereof. Further, it is unnecessary to align the attachment position of the polarizing plates in the conveyance direction of the panels unlike a case where the polarizing plates are attached by a sheet-by-sheet attachment method. Specifically, since the polarizing plate original sheet is cut at a desired position after attachment to a panel in the above configuration, it is not necessary to ensure preciseness of the attachment position in the conveyance direction in attachment and is only necessary to favorably control a cutting position of the polarizing plate original sheet after attachment. Furthermore, the first panel is independent of the second panel after the polarizing plate original sheet is cut, and can accordingly be freely conveyed. Thus, the first panel can be conveyed singly to sites of the subsequent processes, and accordingly, a degree of freedom of processing in the subsequent processes can be increased. Further, the separator film can be continuously and directly peeled off by the peeling section before the polarizing plate original sheet is supplied to the panels. This means that it is not necessary to peel off separator films from the polarizing plates on a sheet-by-sheet basis as in the sheet-by-sheet attachment method.

In one aspect of the polarizing plate attachment apparatus, it is possible that:

the polarizing plate original sheet bears an NG mark indicating a defective point;

the polarizing plate attachment apparatus further includes an NG mark detection section configured to detect the NG mark borne on the polarizing plate original sheet during time until the polarizing plate original sheet pulled out from the feed roll is supplied to the first panel or the second panel;

the conveyance section includes an adjustment mechanism configured to adjust arrival timing when the first and second panels each arrive at the attachment section; and

the controller further includes an adjustment mechanism control section configured to control the adjustment mechanism so that when the NG mark is detected by the NG mark detection section, the arrival timing of the first and second panels is a timing with which a part of the polarizing plate original sheet where the NG mark is borne is not attached to the first panel and the second panels.

In the above configuration, a point of a defect, which may cause a bright point or the like on a panel, is marked as the NG mark and the NG mark detection section detects the NG mark. As such, the conveyance speed control section controls, upon receiving information indicating that the NG mark has been detected by the NG mark detection section, the conveyance speed so that the polarizing plate original sheet can be attached to the panels in a manner that a region of the polarizing plate original sheet where the NG mark is borne is sidestepped. Thus, production of a panel having a defect can be obviated, thereby increasing yield.

In one aspect, the polarizing plate attachment apparatus, it is possible that:

the adjustment mechanism includes conveyance rollers configured to convey the first and second panels; and

an alignment stage configured to receive placement of the first panel or the second panel on the conveyance rollers and temporarily suspend movement of the first panel or the second panel on the conveyance rollers.

In the above configuration including two conveyance means of the conveyance rollers and the alignment stage, a degree of conveyance freedom can be increased. For example, it is possible that the panels are usually conveyed by the conveyance rollers and the position and orientation of a panel are corrected as needed using the alignment stage. Furthermore, the panel can be conveyed with a specific timing as needed using the alignment stage.

In one aspect, the polarizing plate attachment apparatus it is possible that:

the adjustment mechanism includes a conveyance rollers configured to convey the first and second panels and capable of changing a conveyance speed of the first and second panels.

In the above configuration including the conveyance rollers capable of changing the conveyance speed, a degree of conveyance freedom can be increased.

In one aspect, the polarizing plate attachment apparatus may further includes:

an aligning and cutting section disposed downstream of the original sheet cutting section in terms of a conveyance direction of the first and second panels and configured to cut the polarizing plate original sheet attached to the first panel into a polarizing plate having a specific size.

In the above configuration, the polarizing plate original sheet can be cut into the polarizing plates having a desired size by the aligning and cutting section. In particular, provision of the two cutting sections of the original sheet cutting section and the aligning and cutting section can achieve high-speed cutting of the polarizing plates from the polarizing plate original sheet with high precision.

In one aspect, the polarizing plate attachment apparatus may further include

a pressing section disposed downstream of the attachment section in terms of a conveyance direction of the first and second panels and configured to press the first panel and the second panel to which the polarizing plate original sheet has been attached.

In the above configuration, the panel can be secured by the pressing section in attachment of the polarizing plate original sheet to a panel. This can assist conveyance of the panel. In detail, the polarizing plate original sheet is in a belt-shape and is attached continuously. Therefore, a tension is caused in the polarizing plate original sheet. The tension pulls a panel through the polarizing plate original sheet toward the supply section in attachment of the polarizing plate original sheet to the panel. In the above situation, the panel can be secured by the pressing section. Thus, conveyance of the panel against the tension can be assisted.

In one embodiment, a polarizing plate attachment method according to the present invention includes:

providing a polarizing plate original sheet, a first panel, and a second panel, the polarizing plate original sheet being a belt-shaped polarizing plate original sheet including a polarizing film, an adhesive, and a separator film;

peeling off the separator film from the polarizing plate original sheet;

supplying to the first and second panels the polarizing plate original sheet from which the separator film has been peeled off; and

cutting, after a completion of attachment of the polarizing plate original sheet to the first panel and after a start of attachment of the polarizing plate original sheet to the second panel, the polarizing plate original sheet continuously attached to the first panel and the second panel in a line between the first panel and the second panel, the second panel being conveyed subsequently to the first panel.

According to the above method, the belt-shaped polarizing plate original sheet is continuously attached to the panels and cut after attachment to obtain the polarizing plates having a specific size. This avoids attachment of the polarizing plate starting from an end thereof. Therefore, a situation can be avoided in which air enters from an end of the polarizing plate to generate a bubble between the panel and the polarizing plate.

### REFERENCE SIGN LIST

1 polarizing plate attachment apparatus
2 polarizing plate original sheet
2a protection film
2b polarizing film
2c separator film
2d adhesive
3 polarizing plate
4 and 4a to 4f liquid-crystal panel (panel)
5 feed roll
6 winding roll
10 supply section
10a to 10d direction changing roller
11 peeling section
11a separator bar
12 NG mark detection section
13 conveyance section
13a conveyance roller
13b alignment stage
14 attachment section
14a and 14b attachment roller
15 attachment detection section
16 pressing section
16a pressing roller
17 original sheet cutting section
18 aligning and cutting section
30 controller
31 cutting determination section
32 first cutting control section (cutting control section)
32 second cutting control section
35 conveyance speed control section
36 pressing section control section

1. A polarizing plate attachment apparatus comprising:
a supply section configured to supply a polarizing plate original sheet to a first panel and a second panel by pulling out the polarizing plate original sheet from a feed roll, the polarizing plate original sheet being a belt-shaped polarizing plate original sheet including a polarizing film, an adhesive, and a separator film, the polarizing plate original sheet being wound around the feed roll,
a peeling section configured to peel off the separator film from the polarizing plate original sheet during time until the polarizing plate original sheet pulled out from the feed roll is supplied to the first panel or the second panel;
a conveyance section configured to convey the first and second panels;
an attachment section configured to attach the polarizing plate original sheet from which the separator film has been peeled off to the first and second panels through the adhesive;
an attachment detection section configured to detect an attachment state of the polarizing plate original sheet attached by the attachment section;
an original sheet cutting section configured to cut the polarizing plate original sheet;
a controller including a cutting determination section and a cutting control section, the cutting determination section being configured to determine, when the attachment detection section detects that attachment of the polarizing plate original sheet to the first panel has been completed and attachment of the polarizing plate original sheet to the second panel conveyed subsequent to the first panel by the conveyance section has been started, that cutting of the polarizing plate original sheet is enabled, the cutting control section being configured to control, when the cutting determination section determines that cutting of the polarizing plate original sheet is enabled, the original sheet cutting section to cut the polarizing plate original sheet between the first panel and the second panel, and
a pressing section disposed downstream of the attachment section in terms of a conveyance direction of the first and second panels and configured to press the first and second panels to which the polarizing plate original sheet has been attached, wherein
the controller further includes a pressing section control section configured to control the pressing section to secure the first panel until the polarizing plate original sheet is cut between the first panel and the second panel and not to secure the first panel after the polarizing plate original sheet is cut between the first panel and the second panel.

2. The polarizing plate attachment apparatus according to claim 1, wherein
the polarizing plate original sheet bears an NG mark indicating a defective point,
the polarizing plate attachment apparatus further comprises an NG mark detection section configured to detect the NG mark borne on the polarizing plate original sheet during time until the polarizing plate original sheet pulled out from the feed roll is supplied to the first panel or the second panel,
the conveyance section includes an adjustment mechanism configured to adjust arrival timing when the first and second panels each arrive at the attachment section, and
the controller further includes an adjustment mechanism control section configured to control the adjustment mechanism so that when the NG mark is detected by the NG mark detection section, the arrival timing of the first and second panels being a timing with which a part of the polarizing plate original sheet where the NG mark is borne is not attached to the first panel and the second panels.

3. The polarizing plate attachment apparatus according to claim 2, wherein
the adjustment mechanism includes:
conveyance rollers configured to convey the first and second panels; and
an alignment stage configured to receive placement of the first panel or the second panel on the conveyance rollers and temporarily suspend movement of the first panel or the second panel on the conveyance rollers.

4. The polarizing plate attachment apparatus according to claim 2, wherein
the adjustment mechanism includes a conveyance rollers configured to convey the first and second panels and capable of changing a conveyance speed of the first and second panels.

5. The polarizing plate attachment apparatus according to claim 1, further comprising
an aligning and cutting section disposed downstream of the original sheet cutting section in terms of the conveyance direction of the first and second panels and configured to cut the polarizing plate original sheet attached to the first panel into a polarizing plate having a specific size.

6. (canceled)

7. A polarizing plate attachment method comprising:
providing a polarizing plate original sheet, a first panel, and a second panel, the polarizing plate original sheet being a belt-shaped polarizing plate original sheet including a polarizing film, an adhesive, and a separator film;
peeling off the separator film from the polarizing plate original sheet;
supplying to the first and second panels the polarizing plate original sheet from which the separator film has been peeled off;
cutting, when it is determined that cutting of the polarizing plate original sheet is enabled through detection of a completion of attachment of the polarizing plate original sheet to the first panel and a start of attachment of the polarizing plate original sheet to the second panel, the polarizing plate original sheet continuously attached to the first panel and the second panel in a line between the first panel and the second panel, the second panel being conveyed subsequently to the first panel; and
pressing the first and second panels to which the polarizing plate original sheet has been attached downstream of a location where the polarizing plate original sheet is attached to the first panel and the second panel in terms of a conveyance direction of the first and second panels, the pressing securing the first panel until the polarizing plate original sheet is cut between the first panel and the second panel and not securing the first panel after the polarizing plate original sheet has been cut between the first panel and the second panel.
